(19) United States
(12) Patent Application Publication
(10) Pub. No.: US 2013/0335817 A1
(43) Pub. Date: Dec. 19, 2013

(54) MULTIPLE LIGHT SOURCE MICROSCOPE

(71) Applicants: Shinichiro Isobe, Fukuoka (JP); Takaaki Kanemaru, Fukuoka (JP); Shin-ichi Takasu, Tokyo (JP)

(72) Inventors: Shinichiro Isobe, Fukuoka (JP); Takaaki Kanemaru, Fukuoka (JP); Shin-ichi Takasu, Tokyo (JP)

(21) Appl. No.: 13/976,556

(22) PCT Filed: Jan. 5, 2011
(86) PCT No.: PCT/JP2011/050044

§ 371 Date: Sep. 6, 2013

(51) Int. Cl. G02B 21/06; G02B 21/04

(52) U.S. Cl. CPC G02B 21/06; G02B 21/04
USPC 359/363; 359/364; 359/365

(57) ABSTRACT

Provided is a multiple light source microscope which is capable of performing not only electron image observation but also fluorescence image observation, fluoroscopic image observation and the like for the same biological tissue sample, and is provided with a plurality of observation-use light sources. Disclosed is this multiple light source microscope configured by: an optical microscope unit for observing fluorescence, provided with a light source unit; and a scanning electron microscope unit, wherein the optical microscope has a Cassegrain mirror with an aspherical reflecting surface, and the Cassegrain mirror is arranged in a lens barrel of the scanning microscope unit so as to be coaxial with an optical axis of an electron beam of the scanning electron microscope unit.

### BACKGROUND OF THE INVENTION

The present invention relates to a multiple light source microscope which is provided with a plurality of light sources and is capable of observing sample at the same position.

In medical biotechnology field including such as development of disease diagnosis method, observation of a body tissue with a fluorescence microscope is performed after performing immunostaining of a biological tissue with a fluorescent dye. However, the resolution of this method is limited to about 1000 times. In contrast, as a method for observing analysis point of a living tissue sample which is labeled with a fluorescent dye at high magnifications, a method has been proposed in which fluorescence is generated by irradiating the sample (cathodoluminescence) with an electron beam of a scanning electron microscope (hereinafter referred to as SEM) and the fluorescence is observed (For example, JP11-260303). Further, although relating to the analysis of the semiconductor wafer or the like, a surface analyzer has been proposed in which both of X-ray spectrum and fluorescence spectra of analysis point of a sample is measured by combining SEM and an optical microscope so as to perform in a single apparatus the sample excitation with light and the sample excitation by charged particles (For example, JP5-113418).

### BRIEF DESCRIPTION OF THE DRAWINGS

FIG. 1 is a schematic diagram showing an example of a configuration of multiple light source microscope according to the first embodiment.

FIG. 2 is a schematic diagram showing an example of the configuration of an optical microscope in the first embodiment.

FIG. 3 is a schematic diagram showing another example of the configuration of an optical microscope in the first embodiment.

FIG. 4 is a schematic view showing another example of the configuration of a light source unit of the optical microscope in the first embodiment.

FIG. 5 is a schematic diagram showing an example of a configuration of multiple light source microscope according to the second embodiment.

FIG. 6 is a schematic view showing another example of the configuration of a light source unit in the second embodiment.

FIG. 7A is a photomicrograph of astrocytes of a rat neural tissue in Example 1 and shows a fluorescence image.

FIG. 7B is a photomicrograph of the rat spinal cord in Example 1 and shows a fluorescence SEM image of astrocytes.

FIG. 8 is photomicrographs of kidney (tubular) of a rat in Example 2: (a) is a SEM image; (b) is a fluorescence image; (c) is a fluorescence SEM image; and (d) is the partial enlarged image of (a).

FIG. 9A is a photomicrograph of lymph node tissue containing macrophages in Example 3 and shows a SEM image.

FIG. 9B is a photomicrograph of lymph node tissue containing macrophages in Example 3 and shows a fluorescence image.

FIG. 9C is a photomicrograph of lymph node tissue containing macrophages in Example 3 and shows a fluorescence SEM image.

FIG. 10 is a photomicrograph of mouse fundus oculi containing labeled neovessel and macrophages in Example 4: (a) is a SEM image; (b) is a fluorescence image; and (c) is a fluorescence SEM image.

### SUMMARY OF THE INVENTION

By combining SEM with an optical microscope, it can be expected that an object is identified from the morphological characteristics of the analysis point in a short time by observing immediately with SEM the analysis point of the sample consisting of a body tissue that is labeled with a fluorescent dye. However, as its resolution is not enough, the analyzer available for practical use, which comprises a combination of SEM and an optical microscope and can be used for observing the living tissue, has not been reported.

Furthermore, not only the combination of SEM and an optical microscope, the combination of SEM and X-ray microscope or the combination of SEM, an optical microscope and X-ray microscope is also required. Accordingly, it is an object of the present invention to provide a multiple light source microscope which is provided with a plurality of light sources and is capable of observing fluorescence image and perspective image as well as electronic image of the same biological tissue sample.

In order to solve the problem, a multiple light source microscope of the present invention which is capable of observing a sample at the same position, comprises an optical microscope unit for observing fluorescence, provided with a light source unit, and a scanning electron microscope unit, wherein the optical microscope has a Cassegrain mirror with an aspherical reflecting surface, and the Cassegrain mirror is arranged in a lens barrel of the scanning microscope unit so as to be coaxial with an optical axis of an electron beam of the scanning electron microscope unit.

Further, a multiple light source microscope of the present invention which is capable of observing a sample at the same position, comprises at least a light source unit comprising an electron gun, one or more laser light source and X-ray source which are arranged so as to be movable in the optical axis position, an optical system for irradiating a sample with electromagnetic waves or electron beams from the light source unit, and a detection unit having a fluorescent screen comprising cerium-doped YAG and used for detecting an electromagnetic wave or electron beam transmitted through the sample.

As a plurality of optical sources are configured so that their optical axis are coaxial with each other, the present invention can provide a multiple light source microscope capable of performing observation of fluorescence image and electronic image, or observation of fluorescence image, electronic image and X-ray fluoroscopic image only in a single device without moving the sample. Thus, without being affected by positional deviation, physical and chemical changes caused by storing and taking out the sample, observation and analysis of the sample at the same position is possible, and reduction of the foot space is also possible.

According to the present invention, when using an electron gun as a light source, secondary electron image observation, reflected electron image observation, transmitted electron image observation, EDX observation and STEM observation are possible, and when using as a light source, image observation by Kohler illumination and fluorescence image observation by Kohler illumination are possible, and when using X-ray as a light source, fluoroscopic X-ray image observation, 3D fluoroscopic X-ray image observation, observation of cathodoluminescence by electron beam irradiation and measurement of Raman fluorescence by laser irradiation, and the like are possible. Incidentally, the observation target of the present invention is not limited to living tissue, but also contains a variety of materials such as metals, semiconductors, ceramics and plastics which are the targets of the conventional electron microscope, X-ray microscope and optical microscope.

### DETAILED DESCRIPTION OF THE PREFERRED EMBODIMENTS

Hereafter, embodiments of the present invention will be explained in detail with reference to the drawings. Embodiment 1.

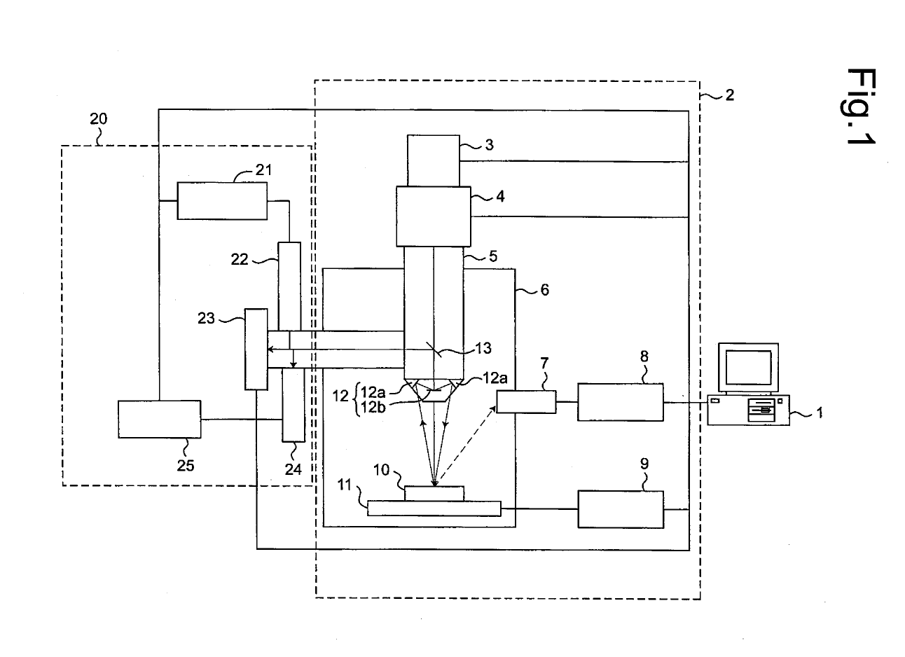

FIG. 1 is a schematic diagram showing an example of a configuration of a multiple light source microscope according to the present embodiment. The multiple light source microscope comprises a system control unit 1 consisting of a host computer 1, a SEM unit 2 and an optical microscope unit 20. In the SEM unit 2, an electron beam is generated and accelerated in the electron beam generating unit 3, and then the electron beam is two-dimensionally scanned by an electron beam scanning unit 4 and is irradiated to sample 9 through a barrel unit 5 disposed in a vacuum chamber 6. Although a reflection mirror 13 of the optical microscope is arranged in the barrel portion 5, the electron beam reaches to a sample 10 through passage hole (not shown) of the reflection mirror 13. Further, 11 is a sample stage for moving the sample 10 in X-Y direction and is driven by a sample stage controller 9. The secondary electron generated by electron beam irradiation to the sample 10 is detected by a detector 7 and is amplified by an amplifier 8.

On the other hand, the optical microscope 20 comprises a light source unit for illumination 21 which is disposed at a position away from the optical axis of the SEM unit, an illumination unit 22, an observation camera 23, an optical fiber unit 24 for collecting a fluorescence from sample 9 and a spectrometer 25 for measuring the fluorescence intensity of the fluorescence from the optical fiber unit 24.

For example, when observing an optical image of the sample 10, a light from the light source unit 21 of the optical microscope 20 is irradiated from the illumination unit 22 to the reflective mirror 13 by optical system (not shown) such as a half mirror or lens. Then, the light reflected by the reflecting mirror 13 travels along the optical axis of the electron beam in the SEM unit and reaches the Cassegrain mirror 12 which is arranged in the barrel unit 5. The Cassegrain mirror 12 comprises one large mirror 12a having a central opening and arranged above, and a small mirror 12b which is arranged below the central opening, and the large mirror 12a and the small mirror 12b are disposed so as to oppose each other. The light from the reflecting mirror 13 passes through the opening of the large mirror 12a and is reflected by the small mirror 12b, and then the reflected light is collected and irradiated onto the sample 10 by a large mirror 12a.

Then, the light from the sample 10 is reflected by the large mirror 12a and then by the small mirror 12b, and travels to the reflecting mirror 13. The light reflected by the reflecting mirror 13 is turned to the optical fiber unit 24 and the observation camera 23 by the optical system (not shown) such as a half mirror or lens.

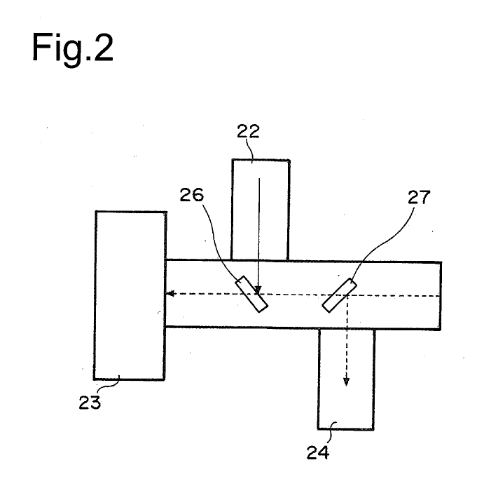

FIG. 2 is an enlarged view of a light path of return light and shows an example for introducing the return light to the optical fiber unit and the observation camera using a half mirror. That is, the light from the light source unit 21 of the optical microscope 20 is turned and irradiated from the illumination unit 22 to the reflecting mirror 13 by the half mirror 26 and 27. On the other hand, the return light from the sample is reflected by the reflection mirror 13 and turned to the optical fiber 24 and the observation camera 23 by the half mirror 26 and 27.

The observation of the fluorescently labeled sample is performed using an optical microscope at magnification of several hundred times, and then the observation of the desired sample area is performed using SEM at a higher magnification.

Here, in SEM unit, the secondary electrons and the like which are generated by scanning electron beams under the control of the host computer 1 are detected by the detecting element 7 and converted to electric signals with I-V amplifier (not shown), and then the electric signals are converted by A/D-converter (not shown) of the host computer 1, and thereby obtaining a SEM image. Further, the optical microscope unit includes a fluorescence selection filter (not shown) and an observation camera (for example, CCD camera), and detects a fluorescence image with the CCD camera displayed with the target wavelength that is selected by the fluorescence selection filter, and sends it to the host computer 1 as a digital signal. As for the SEM image and fluorescent image sent to the host computer 1, a synthesis (superposition) is performed by the host computer 1 using image synthesis system software.

In this embodiment, the aspheric type Cassegrain mirror is used. That is, the Cassegrain mirror comprises a large mirror having an opening in the center and a small mirror disposed below the opening so as to face the large mirror, and the reflective surfaces of the large mirror and the small mirror are aspherical surfaces. Conventional Cassegrain mirror include a concave mirror having an opening in the center and a convex mirror which is smaller than the concave mirror, and shape of the reflecting surface is a spherical surface such as parabolic, ellipsoid or hyperboloid. However, when the reflecting surface is spherical, an optical image cannot be superposed with an electron microscope image, because the peripheral portion of the optical image is distorted when observing the optical image. However, in this embodiment, as the Cassegrain mirror comprising a large mirror and a small mirror whose reflecting surfaces are asperical type is employed, a superposition of the optical image with the electron microscope can be easily performed, because the distortion of the peripheral portion of the optical image does not occur. As this can further improve the resolution, fluorescence observation at high magnification can be performed. Here, the non-spherical type means that the reflecting surface is not spherical type such as parabolic, ellipsoid, or hyperboloid described above, and concretely means a flat surface. A more detail explanation about the effect is described below. By making the reflecting surface of the Cassegrain mirror to aspherical, lens aberration (phenomenon that the shape of the image plane and the shape of the object plane is not a similar shape), which is one of Seidel abberrations, can be improved, spherical aberration (a phenomenon that the imaging position is different depending on the difference in the numerical aperture N.A. in the axial ray) and coma aberration (a phenomenon that, even when the spherical aberration is corrected to be sufficiently small, rays emitted from off-axis object point cannot converge on one point on the image plane and thereby forming asymmetric bokeh tailing like a comet) and the like are also improved simultaneously. Furthermore, chromatic aberration (a phenomenon that, as glass used in the optical system has a characteristic that the refractive index varies according to each wavelength, the focal distance is different for each wavelength and thereby generating the displacement of the imaging position), which is one of the optical problem, is also improved simultaneously, and when superposing the optical image with the electron microscope image, the displacement of the fluorescence image which is observed with the optical microscope does not occur within the range of vision.

In this embodiment, it is preferable that the amount of light of the return light which is reflected from the sample is in the range of 60 to 90% of the amount of the irradiation light of a light source. More preferably it is in the range of 70 to 90%, and still more preferably 70%. By suppressing the amount of return light, since the amount of return light which is reflected from the sample increases, observation becomes possible without using an expensive high sensitivity observation camera. Further, it is also possible to observe visually by replacing the observation camera observation camera with binoculars or monocular.

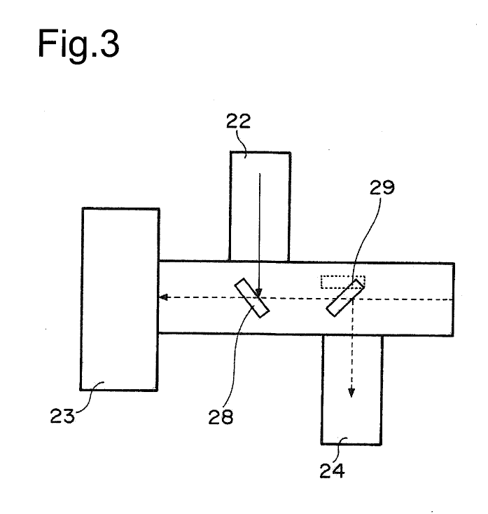

In this embodiment, the optical microscope may be provided with a light path switching mechanism for switching optical path of the return light from the sample to either one of the optical fiber side or the observation camera side. FIG. 3 is a schematic view showing a structure of an optical microscope having an optical path switching mechanism. The half mirror 28 turns and irradiates the light from the light source unit 21 of the optical microscope 20 toward a reflecting mirror 13 of the illumination unit 22, and also turns the return light from the sample toward the observation camera 23 side. On the other hand, 29 is a switching mirror for the optical path switching mechanism. Incidentally, in FIG. 2, the half mirror 27 is provided in place of the switching mirror 29. Switching mirror 29 switches the optical path of the return light from the sample to either one of the optical fiber unit 24 side or the observation camera 23 side. Specifically, when not performing detection of fluorescence from a sample, switching mirror 29 is disposed in parallel with the light path of the return light so that the optical path of the return light may not be interrupted. On the other hand, when performing detection of fluorescence from a sample, switching mirror 29 is disposed so that the optical path of the return light may be interrupted, and the return light is reflected and is introduced into the optical fiber unit 24. At this time, it is preferable that equal to or more than 95% of the return light is reflected. By switching the switching mirror 29 so as to be in parallel with the light path of the return light, 100% of the return light from the sample can be allowed to pass to the observation camera 23 side to provide good observation of the image of the dark fluorescence image or the like. Further, by switching the switching mirror 29 so that the optical path of the return light may be interrupted, part of the light of the return light from the sample can be allowed to pass to the observation camera 23 side, and it can be confirmed whether the irradiation light from the illumination unit 21 is irradiated to the intended measuring position or not. Furthermore, by guiding the return light reflected by the switching mirror 29 to the spectrometer 25 via the optical fiber unit 24, fluorescence spectrometry, Raman measurement and cathode luminescence measurement of the above intended measuring position of the sample become possible. However, when there is no light path switching mechanism as shown in the embodiment of FIG. 1, fluorescence spectroscopy, Raman measurement and cathode luminescence measurement are difficult.

A monochromic light such as a laser beam, white light, and a combination thereof may be used for the light source of the optical microscope unit. Further, as for the illumination unit, it is preferable that the spot lighting or Koehler illumination are possible. For example, a fluorescence microscope may be constituted by using a laser beam for the light source and also using Koehler illumination for the illumination unit. Further, a scanning laser microscope may be constituted by using a laser beam for the light source and using a spot light for the illumination unit, and scanning a sample stage in X-Y direction to carry out I/V conversion of the return light with the detector and to synchronize with the scanning signal of the sample stage and thereby to display as a X-Y map. Further, it is also possible to constitute a confocal scanning laser microscope by adjusting the position of the detector. Further, it is also possible to constitute a microscope capable of Raman and fluorescence measurements by using a laser beam for the light source, using a spot light for the illumination unit, and guiding the return light to the spectrometer. Further, it is also possible to constitute a microscope capable of Raman and fluorescence measurements in three dimensions by using a laser beam for the light source, using a spot light for the illumination unit, and scanning a sample stage in X-Y direction to guide the return light to the spectrometer, and synchronizing with the scanning signal of the sample stage while carrying out a spectral analysis on each scanning position and thereby to display as a X-Y map. Here, both X and Y axes serve as positional information on a sample surface, and Z-axis direction serves as a wavelength axis of a spectral analysis.

Further, when using a plurality of fluorescence dyes whose excitation wavelength are different from each other, the observation of the fluorescence image of the sample can be performed by disposing a plurality of monochromatic light sources such as a laser beam in the light source unit 21, causing each fluorescence dye to emit fluorescence at each excitation wavelength while switching each monochromatic light source and obtaining a plurality of fluorescence images, and then synthesizing a plurality of fluorescence images by image processing.

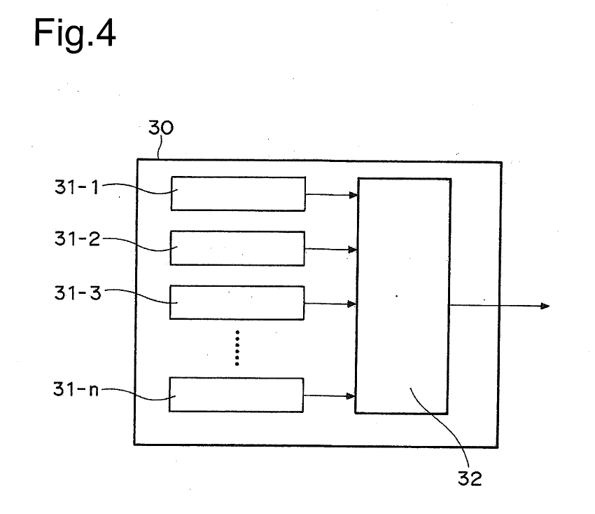

Alternatively, as a light source of the optical microscope, those of including a plurality of monochromatic light source and a light synthesizing means to produce a synthetic light by mixing lights from a plurality of monochromatic light sources can be employed. FIG. 4 is a schematic diagram showing an example of a light source unit 21 including a plurality of monochromatic light sources. The light source 21 includes a plurality of monochromatic light sources 31-1, 31-2, 31-3, . . . , 31-n (n is an integer of two or more), and a light synthesizing module 32 for producing a synthetic light by mixing lights from a plurality of monochromatic light. Thus, as the synthetic light of the monochromatic lights can at once be irradiated to the sample labeled with a plurality of fluorescence reagents, measurement procedure can be simplified as compared with the above mentioned procedure of switching each monochromatic light source. Further, since the image synthesis of a plurality of fluorescence images is not necessary, alignment of a plurality of fluorescence images associated with the image synthesis is not required. When producing a fluorescence SEM image by obtaining a plurality of fluorescence images by switching each monochromatic light source, it is necessary to determine the gravity center position of each fluorescence image, and to perform position adjustment and observation magnification correction of each fluorescence image so that the gravity center position of each fluorescence image may be coincided with that of the SEM image. In contrast, in embodiments employing the light synthetic means described above, it is not necessary to perform positional adjustment and observation magnification correction of each fluorescence image, it is only necessary to perform positional adjustment and observation magnification correction of arbitrary one or more of fluorescence images. Thus, since the drift correction of the optical axis/the drift problem of the sample stage caused by the installation environment of the device accompanied with the observation of a plurality of fluorescence images can be reduced, it is possible to obtain the fluorescent image and the SEM image having distinct outlines and thereby to obtain a clearer image with higher resolution. There is also an advantage that the time savings of sample measurement and simplification of post-processing work can be expected.

The light synthesizing module can irradiate a light having a color close to white light by simultaneously irradiating monochromatic light of red, blue and green, and thus can irradiate a sample with a white illumination light which is different from a white laser, and thereby allowing observation of the sample as a stereo optical microscope. For example, the light synthesizing module can be constituted by a one-dimensional optical modulator including a plurality of elements arranged in one direction for modulating red, blue and green light, respectively, a synthesizing mirror for synthesizing the modulated light, and a projection optical system for producing a projection image from the modulated light and the like.

The method for preparing an observation sample used in this embodiment is not particularly limited, any preparation method conventionally used for the observation using microscope such as embedding using thin sections of the sample and freezing method can be used. Further, the method of fixing the piece of a sample itself on a supporting substrate for observing a substance is also included. As for fluorescence dye, it is preferable to use fluorescence dyes described in the International Publication WO/20081013260. By using the fluorescence dyes (oxadiazolopyridine derivatives) described in the above International Publication, it is possible to provide a permanent sample in which the fluorescence from the fluorescence dyes does not disappear even after prolonged storage. That is, while the biological sample labeled with the conventional fluorescence dye fades in around one week, the biological sample labeled with the above fluorescence dye can be semipermanently stored as long as it can be refrigerated. Further, it is cheaper as compared with the conventional fluorescence dye. Further, since it can give high fluorescence intensity even for the sample which is substantially in a dry state, still more reliable pathological diagnosis is possible.

One example of a sample preparation method when performing a bulk observation and an etching section observation is shown below. For sample preparation, the following reagents can be used in common.

a) A fluorescence dye described in the above International Publication or Alexa-based dye, which have a high electron beam tolerance, can be used for immunostaining and lectin staining.
b) Dehydration in ascending concentration order with Acetone as a dehydrating agent can be used (twice (each 7 minutes) 50-75-85-95-100%)

### (Sample Preparation Method for Bulk Observation)<

### <A: Perfusion Fixation>

1) A phosphate buffer solution containing 2.8% paraformaldehyde, 0.2% picric acid and 0.06% glutaraldehyde is used as a fixation solution. For post-fixation, a phosphate buffer solution containing 4% paraformaldehyde is used.

### <B: Freeze Fracturing Method (DMOS Method)>

2) After fixation with 4% paraformaldehyde, the sample is sufficiently washed with PBS, and the solution is replaced from 30% DMSO to 50% DMSO, and then the sample sealed in 50% DMSO is fractured with freeze fracturing apparatus (liquid nitrogen) and washed.

### <C: Fluorescence Labeling>

3) After washing with PBS, the sample is labeled with a fluorescence dye by using immunofluorescence method and lectin staining.

### <D: Sample Treatment-1)

4) After turning the sample labeled with fluorescence dye to an acetone dehydration system, the solution is replaced with dehydration in ascending concentration order of tert-butylalcohol [(50−100%)×2 (each 5 minutes)]. A bulk sample is obtained by drying the sample in a freeze dryer (RD-1 manufactured by Eiko).

### <E: Coating>

5) After the sample is adhered onto a sample holder for SEM with carbon double-sided tape or the like, osmium film having a thickness of about 2 nm is formed on the sample by using osmium coater (manufactured by Vacuum Device ID-2).

### (Sample Preparation Method for Etching Observation)

The procedures are the same as that for the above sample preparation method for bulk observation except that the following method is used for sample treatment.

### <D; Sample Treatment-2>

6) After labeling and dehydration, the sample is embedded in hydrophilic plastic (Technovit 8100), and a section having a thickness of about 5 μm is cut out from the sample using a diamond knife for optical microscope and an ultramicrotome. In order to ensure the fluorescence intensity, the thickness of the section may be 10 μm.
7) A silicon substrate for wafer which is divided into 8 mm square chips is used as a plate for mounting sample, and the sample is mounted on the chip.
8) Performing ion etching to substrate sample and thereby to obtain a section sample. Ion etching is performed at 13 mA/8 min using PIB-10 manufactured by a vacuum device company.

According to this embodiment, since the Cassegrain mirror of the optical microscope is disposed in the barrel of the SEM so as to be coaxial with the optical axis of the electron beam of the SEM system, SEM observation and fluorescence observation are possible with one device without moving the sample. Thereby, without being subject to the influence of the positional deviation, physical and chemical changes caused by taking in and out the sample, observation and analysis of the sample at the same position become possible, and a foot space is also reduced.

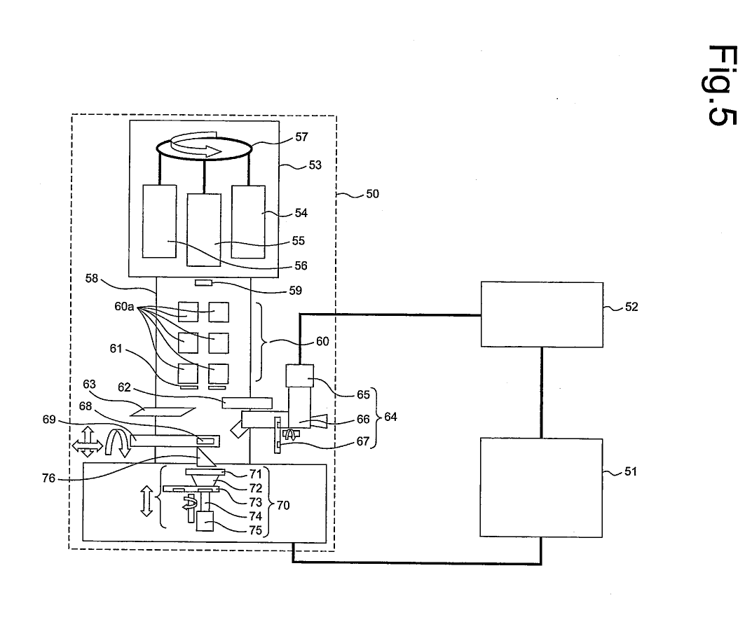

Further, conventionally, the reflecting surface of the Cassegrain mirror constituting an optical microscope is a spherical shape, the peripheral portion is distorted when viewed an optical image, and could not be superimposed with the electron microscope image. However, in the present invention, since the Cassegrain mirror whose reflection surface is aspherical is used, there is no distortion around the optical image, and the superposition with an electron microscope image is easy and thereby to improve the resolution. Thereby, it becomes possible to perform an immediate magnifying observation of fluorescently labeled portion of the sample. Accordingly, quick identification of the labeled portion becomes possible. Embodiment 2 FIG. 5 is a schematic diagram showing an example of a configuration of multiple light source microscope according to the present embodiment. A multiple light source microscope is constituted of a system control unit 51 consisting of a host computer, a spectrometer 52 and a microscope unit 50. A microscope 50 includes a light source unit 53 including a plurality of light sources 54, 55, 56 and a light source holding mechanism 57 for holding those light sources so as to be movable to the optical axis position, an optical system 60 including a plurality of electromagnetic lenses 60a which are arranged in the barrel 58 and accelerate the electron beam from the light source and irradiate it to a sample, a sample tube 69 for holding the sample 68 which is movable in X-Y direction and rotatable, a detection unit 70 for detecting a transmitted electron through the sample, and a observation unit 64 which is disposed outside the barrel 58. The detection unit 70 is constituted of a fluorescent screen to which the transmitted electron through the sample reach, a fiber taper 72 to which the fluorescent screen is attached, a lens unit 74, a CCD/CMOS detector 75, and a filter 73 attached between the fiber taper 72 and the lens unit 74. Further, the observation unit 64 is constituted of a three lens barrel 66 to which an external CCD camera 65 and a fluorescence filter 67 are attached. Further, 59 is a partition plate for blocking between the light source unit and the barrel. That is, when switching the light source of the light source unit, if the air is induced into not only the light source unit but the whole lens barrel in a vacuum state, it takes much time to return to the vacuum state. Therefore, by blocking between the light source unit and the barrel with the partition plate, the time required for the air induction into the light source unit and the re-evacuation can be shortened. Further, 61 is a backscattered electron detector for detecting backscattered electrons from the sample. Further, 62 is a secondary electron detector for detecting secondary electrons from the sample. Further, 63 is an energy dispersive X-ray spectroscopy (EDX) detector. Further, 76 is a movable type small reflective fluorescent screen for leading the transmitted electron from the sample 68 to the observation unit. As a light source of the light source unit 53, three light sources, that is, electron gun 54, laser beam source 55 and X-ray source 56 can be used. In the multi-light source microscope concerning this embodiment, three sorts of these light sources are used, switching them suitably. In the multiple light source microscope according to this embodiment, these three light sources are used by appropriately switching them.

### (Electron Microscope)

It can be used as an electron microscope by using an electron gun for a light source. That is, the electron beam emitted from the electron gun of the light source unit 53 passes through the gate valve 59 and is accelerated by the optical system 60 in the barrel 58 and is irradiated to the sample 68 fixed to the sample tube 69. The Reflected electron from the sample 68 is detected by a reflected electron detector 61. Further, the transmitted electron through the sample 68 passes through the fiber taper 72 and the lens unit 74, and is detected by the CCD/CMOS sensor 75, and thereby imaged on the monitor of the system control unit 51. That is, it can be used as a transmission electron microscope. Here, the magnification can be varied by operating the lens unit 74. Further, by moving the movable type small reflective fluorescent screen 76 to the optical path, the transmitted electron image from the sample 68 can be observed using the three lens barrel 66. Further, elemental analysis becomes possible by detecting X-rays generated from the sample using an EDX detector 63.

Further, it can be used as a scanning electron microscope by scanning the sample tube 69 in X-Y direction and rotating (edirection), and detecting the secondary electron from the sample 68 using the secondary electron detector 62. Further, it is possible to observe the STEM image (scanning transmission electron microscope image) by using the CCD/CMOS sensor 75. Further, it is possible to observe a two-dimensional element map image of the X-Y direction by using the EDX detector 63.

Further, by guiding the emitted light from the sample 68 to the spectroscope 52 by an optical fiber or the like via the three lens barrel 66, cathodoluminescence measurement becomes possible. The two-dimensional cathodoluminescence map image can be observed by scanning the sample tube 69 in the X-Y direction.

### (Laser Microscope)

By using a laser light source for a light source, it can be used as a laser microscope (optical microscope). By using a laser light source to the light source, it is possible to be used as (optical microscope) laser microscope. However, since the optical system is not incorporated in the lens barrel, a laser is irradiated only to a given area as a Koehler illumination. The laser beam emitted from the laser light source of the light source passes through the gate valve 59 and the optical system 60 in the lens barrel 58 and is irradiated to the sample 68 that is fixed in the sample tube 69. By moving the movable type small reflective fluorescent screen 76 in the optical path, it is possible to visually observe the light from the sample 68 with the three lens barrel 66. That is, it can be used as an optical microscope. Further, when the sample is labeled with fluorescence dye, by inserting the fluorescence filter 67 mounted on the three lens barrel 66 in the optical axis and thereby cutting the laser beam (excitation light), it becomes possible to observe a fluorescence image. Further, by guiding the light from the sample to the spectroscope 52 by the optical fiber or the like via the three lens barrel 66, the Raman measurements can be performed. Further, by scanning the sample tube 69 in X-Y direction and rotating (θdirection), three-dimensional optical images or fluorescence images.

Further, when taking picture by the transmitted light, if the COD CMOS detector 75 is used, depending on the sample preparation method, there is a possibility of decreasing the sensitivity of fluorescence dye. Then, taking picture with only the detector 75 may require a long exposure time. However, luminance can be secured by using fluorescent screen 71 as a means to assist it. Further, it is possible to guide an image to the detector 75 while ensuring a large view by taper 72.

A white lase can be used as a laser beam source. Alternatively, a plurality of laser beam sources having different wavelength with each other can be switched and used as needed.

### (X-Ray Microscope)

It can be used as an X-ray microscope by using X-ray source for a light source. That is, X-rays emitted from the X-ray source of the light source unit 53 passes through the gate valve 59 and are accelerated by the optical system 60 of the barrel 58, and then is irradiated to sample 68 which is fixed to 69 sample tube. That is, it is accelerated by optical system 60 in body tube. X ray transmitted through the sample 68 passes through fluorescent screen 71, a fiber taper 72 and the lens unit 74, and is detected by the CCD/CMOS detector 75, and then is imaged and displayed on the monitor of the system control unit 51. That is, it may be used as X-ray electron microscope. Here, the magnification may be varied by operating the lens unit 74.

Further, the transmitted X-ray image from the sample 68 can be observed visually using three lens barrels 66 by moving the movable type small reflective fluorescent screen in the optical path. Further, observation of 3D transmission X-ray image becomes possible by scanning the sample tube 69 in X-Y direction and rotating (θdirection).

Although well-known X-ray source can be used as an X-ray source, it is preferable to use a chip type source.

The fluorescent screen used in this embodiment absorbs the energy of the electron beam and the electromagnetic waves transmitted through the sample and thereby to generate fluorescence. The enlarged image of the transmitted portion of the sample is formed on the fluorescent screen, and then captured by CCD/CMOS detector. Conventionally, a fluorescent screen consisting of P22 powder phosphor is used for electron microscope, and a fluorescent screen of zinc sulfide containing a small amount of silver is used for X-ray microscope. While the detection wavelength of the fluorescent screen for electron microscope is within the range of 0.0037 nm˜0.0025 nm, the detection wavelength of the fluorescent screen for X-ray microscope is within the range of 0.07 nm˜0.15 nm, they cannot be used in common. In contrast, in this embodiment, a cerium-doped YAG fluorescent screen is used. Since the cerium-doped YAG has a detection wavelength within the range of 0.002˜700 nm, it is capable of performing X-ray microscopy observation and electron microscopy observation with only one fluorescent screen.

As the cerium-doped YAG, for example, a single crystal produced by the method described in the following literatures can be used.
1. “Evaluation of properties of YAG (Ce) poly-crystal scintillator with APD” Takayuki Yanagida, Hiromitsu Takahashi, Daisuke Kasama, Takeshi Ito, Hisako Niko, Motohide Kokubun, Kazuo Makishima, Takagimi Yanagitani, Hideki Yagi, Takashi Shigeta, and Takashi Ito Proceedings of Scintillating Crystals and their Applications at KEK, p 111-116.
2 Tadayuki Takahashi: Future Prospects on X-ray and Gamma-ray Mission: 17th Annual October Astrophysics Conference in Maryland, Radiation Backgrounds from the First Stars, Galaxies and Black Holes: (2006)). According to those methods, the ingot of a single crystal can be produced by the Czochralski method (Cz method) or a floating zone method (FZ method). According to the method, the Czochralski method or (Cz method), the ingot of the single crystal can be manufactured by a floating zone method (FZ method). Further, the amount of doped cerium is within the range of 0.005˜0.5 mol %.

Here will be described about the superposition of an electron microscope image and a laser microscope image and/or an X-ray microscope image. The superposition of the transmission electron microscope image and the laser microscope image is described below. The transmitted electron from the sample is detected and photoelectrically converted by the detection unit 70, and is A/D converted by the system control unit 51, and thereby obtaining a transmission electron microscopy image. Further, the laser microscope has a fluorescence selection filter 67 and an external COD camera 65, the fluorescence image displayed with the desired wavelength that is selected by the fluorescence selection filter is detected by the CCD camera, and the obtained fluorescence image is sent to a system control unit 1 as a digital signal. At the system control unit 1, the superposition of the sent transmission electron microscopic image and fluorescence image is performed using an image synthesizing system software.

Further, the superposition of the transmission electron microscope image and the X-ray microscope image is described below. The transmitted electron from the sample is detected and photoelectrically converted by the detection unit 70, and is A/D converted by the system control unit 51, and thereby obtaining a transmission electron microscopy image. The transmitted X-ray from the sample is detected and photoelectrically converted by the detection unit 70, and is A/D converted by the system control unit 51, and thereby obtaining a transmission λ-ray microscopy image. At the system control unit 1, the superposition of the sent transmission electron microscopic image and the transmission λ-ray microscopy image is performed using an image synthesizing system software.

Further, when performing a superposition of the transmission electron microscope image and a laser microscope image and a X-ray microscope image, at the system control unit 1, the superposition of the sent transmission electron microscopic image, the fluorescence image and the transmission λ-ray microscopy image is performed using an image synthesizing system software.

The method for producing the observation sample used in the first embodiment can be used in this embodiment.

When using a plurality of fluorescence dyes having different excitation wavelengths, a laser light source unit including a plurality of laser light sources having different wavelengths is provided in place of the laser light source 55, and the plurality of laser light sources are selectively switched as required, and after obtaining the fluorescence images by making each fluorescence dye emit light at its exiting wavelength, the fluorescence images of the sample can be observed by combining the fluorescence images through a plurality of image processing.

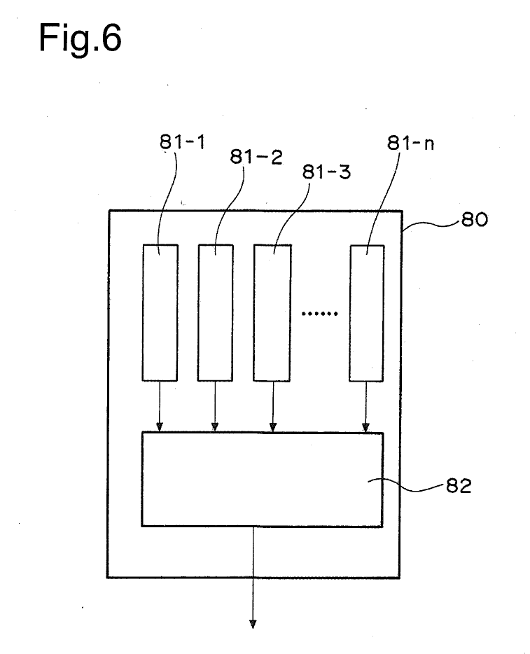

Alternatively, a laser light source unit may include a plurality of laser light sources, and a synthesizing means for synthesizing light by mixing lights from a plurality of laser light sources. FIG. 6 is a schematic diagram showing a configuration of a laser light source unit used in place of the laser light source 55 of FIG. 1. The laser light source unit 80 includes a plurality of laser light sources 81-1, 81-2, 81-3, . . . , 81-n (n is an integer of 2 or more), a light synthesizing module 82 for synthesizing lights from the plurality of laser light sources. Thus, since a synthetic light of a monochromatic light can be irradiated to the sample labeled with a plurality fluorescence dyes at once, the measurement procedure can be simplified as compared to the above method of switching the monochromatic light source. Further, since the image synthesis of a plurality of the fluorescence images is not required, alignment of a plurality of the fluorescence images accompanied at the time of image synthesis becomes unnecessary. When acquiring a plurality of fluorescence images by switching the monochromatic light source and thereby to produce a fluorescence SEM image, it is necessary to compute the centroid position of each fluorescence image, and then to perform position alignment and observation magnification correction of each fluorescence image so that the centroid position of each fluorescence image is coincided with the centroid position of the SEM image. In contrast, in embodiments using the above light synthesizing means, the magnification correction and alignment of the fluorescence images are not required, only observation magnification correction and alignment of at least one arbitrary fluorescence image is sufficient. Thus, since the drift of the optical axis/sample stage caused by the installation environment of the device that is accompanied by observing a plurality of fluorescence images can be reduced, the SEM images and the fluorescence images having clear outline can be obtained and thereby to obtain a clear image by improved resolution. There is also an advantage that the time shortening of the sample measurement and the simplification of after-treatment work can be expected.

According to this embodiment, since the cerium-doped YAG is used as a fluorescent screen, without moving the sample, electron microscope observation, X-ray microscope observation and laser microscope observation is possible in one apparatus. Therefore, without being affected by positional deviation, physical and chemical changes caused by storing and taking out the sample, observation and analysis of the sample at the same position is possible, and reduction of the foot space is also possible. Thus, identification and confirmation of the labeled portion can be quickly performed.

The present invention will be further specifically explained in more detail with reference to the following examples, but the present invention is not limited to the following examples.

### Example 1

### Sample Preparation

Immunostaining to the astrocyte which is a nervous tissue of rat was performed by the following procedure.

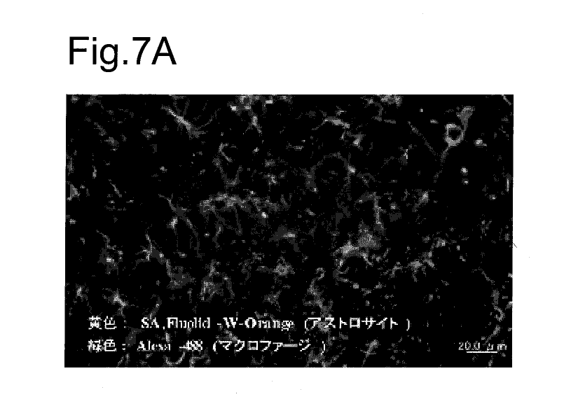

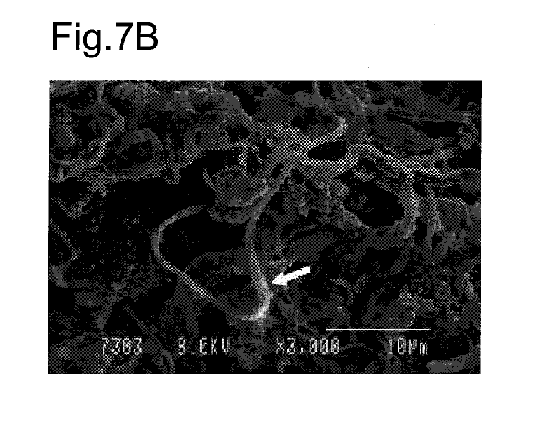

1) Immersion fixation was performed after reflux fixation by 0.1 M PB (Phosphate Buffer) containing 4% paraformaldehyde (3 hours).
2) Wash with 0.1M PB containing 20% sucrose (4° C., overnight)
3) Nerve (spinal cord) tissue was divided into the small sample by the technique according to each use, such as a. cutting with razor, b. freeze fracture for SEM, c. 10 μm frozen-section preparation. The method of (c) was used in the case of FIG. 7A and the method of (a) was used in the case of FIG. 7B to prepare the sample.
4) Wash with 0.1M PB (5-minute×3 times)
5) Blocking by 0.1M PBS (Phosphate Buffered Salts, PBSTBF) containing 0.8% Fish Gelatin, 1% cow serum albumin and 0.2% Triton X-100) (room temperature, 1 hour).
6) The anti-glial fibrillary acidic protein (GFAP) mouse monoclonal antibody (1:20,000; Sigmal) was incubated in PBSTBF (4° C., 14 hours). As a control, only PBSTBF was incubated.
7) Wash with 0.1M PB (5-minute×3 times)
8) Anti-mouse antibody labeled with biotin (1:400; Jackson Lab.) was incubated in PBSTBF (Room temperature, 90 minutes).
9) Wash with 0.1M PB (5-minute×3 times)
10) Streptavidin labeled with Fluolid was incubated in 10 mM HEPES and 0.15M NaCl (pH7.3) for 90 minutes at room temperature. Streptavidin labeled with AMCA (7-amino-4-methlycoumarine-3-acetic acid) (1:200; Jackson Lab.) was incubated in PBSTBF for 90 minutes at room temperature. However, dilution rate was changed depending on the production process of Fluolid.
11) Wash with 0.1M PB (5-minute×3 times) In this example and examples below, Fluolid refers to the fluorescence dye described in the above international application.
(Microscopy Method) As a multiple light source microscope, wavelength dispersion type element analyzer JXA-8600 by JEOL Co. equipped with an optical microscope unit and SEM unit in which the optical system of the optical microscope was modified is used.

### (Results)

FIG. 7A is a fluorescence microscopy image of astrocyte of the rat neutral tissue, and FIG. 7B is a fluorescence SEM image of astrocyte of the rat spinal cord obtained by using a multiple light source microscope of the present invention. By using the multiple light source microscope of the present invention, a clear image which only astrocyte was stained was obtained.

### Example 2

(Sample preparation) Immunostaining to the rat kidney (tubules) was performed by the following procedure.
1) After reflux fixation by 2.8% paraformaldehyd-0.2% picric acid-0.06% glutaraldehyde-0.1 M PB, post fixation was performed with 4% paraformaldehyde in PB and stored at 4° C.
2) A sample was cut into 1 mm sections with a vibratome and the sample was washed by PBS (0.01M) (4° C., one day).
3) Biotinylated Peanut Agglutinin (PNA) (Vector) was incubated in PBS (1:100) (4° C., four days).
4) Wash with PBS (4° C., 20-minutes×3 times)
5) Adding fluorescence dye (4° C., one day) Streptavidin-Fluolid-W-Orange was incubated in PBA (1:10).
6) Wash with PBS (4° C., 20-minutes×3 times)
7) Dehydration with aceton (50-75-85-95-100% dehydration in ascending concentration order)
8) The labeled and dehydrated sample was embedded in hydrophilic plastic (Technovit 8100), and a section having a thickness of about 5-micrometer was produced using the diamond knife for light microscopes and ultramicrotome.
9) The sample was placed on the plate which was made by dividing Si substrate for wafer into 8 mm square.
10) The sample was subjected to ion etching, and was obtained a section sample. Ion etching was performed in 13 mA/8 minutes using PIB-10 manufactured by Vacuum device Co.

### (Results)

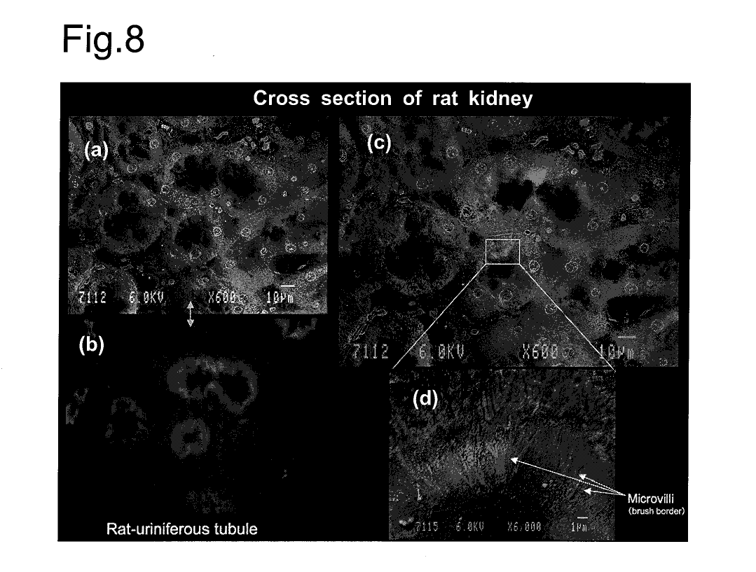

The multi-light microscope used in Example 1 was used for microscopic observation. In FIG. 8, (a), (b) and (c) are a SEM image, a fluorescence image and a fluorescence image obtained using the multi-source microscope of the present invention, respectively, and (d) is a partially enlarged image of (c). From the fluorescence SEM image, it is confirmed that the brush border of a uriniferous-tubule section is selectively stained. Further, it was possible to observe in detail villi tubular inner wall which could not be observed by fluorescence microscopy. Example 3.

### (Sample Preparation)

1) After reflux fixation by 2.8% paraformaldehyd-0.2% picric acid-0.06% glutaraldehyde-0.1 M PB, post fixation was performed with 4% paraformaldehyde in PB and stored at 4° C.
2) A sample was cut into 1 mm sections with a vibratome and the sample was washed by PBS (0.01M) (4° C., one day).
3) Biotinylated Peanut Agglutinin (PNA) (Vector) was incubated in PBS (1:100) (4° C., four days).
4) Wash with PBS (4° C., 20-minutes×3 times)
5) Adding fluorescence dye (4° C., one day) Streptavidin-Fluolid-W-Orange was incubated in PBA (1:10).
6) Washing with PBS (4° C., 20-minutes×3 times)
7) Dehydration with aceton (50-75-85-95-100% dehydration in ascending concentration order)
8) The labeled and dehydrated sample was embedded in hydrophilic plastic (Technovit 8100), and a section having a thickness of about 5-micrometer was produced using the diamond knife for light microscopes and ultramicrotome.
9) The sample was placed on the plate which was made by dividing Si substrate for wafer into 8 mm square.
10) The sample was subjected to ion etching, and was obtained a section sample. Ion etching was performed in mA/8 minutes using PIB-10 manufactured by Vacuum device Co.

### (Results)

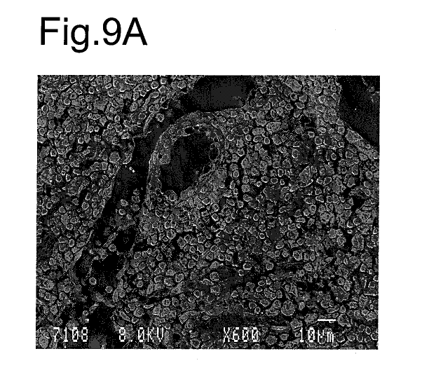

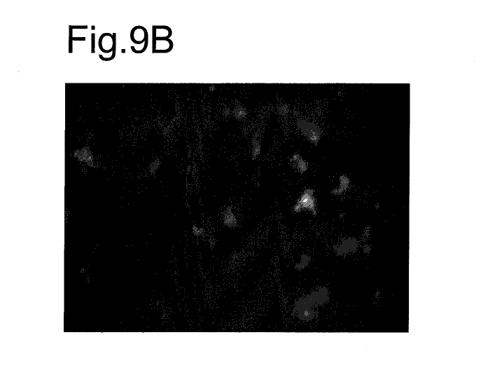

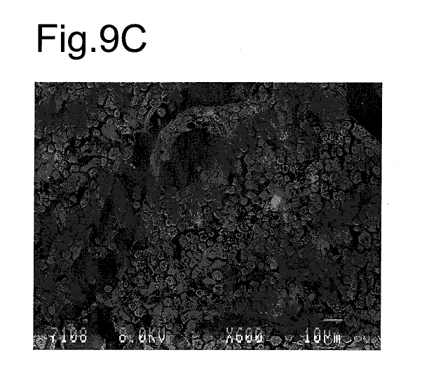

The multi-light microscope used in Example 1 was used for microscopic observation. FIG. 9A, FIG. 9B and FIG. 9C are a SEM image, a fluorescence image and a fluorescence image obtained using the multi-source microscope of the present invention, respectively. The sample is a lymph nodes of rats containing macrophages. Since the macrophage (phagocyte) in the lymphonodus organization has incorporated various wastes in the living body, it is considered that the macrophage has autofluorescence. Then, the fluorescence observation of the lymph nodes was performed without staining using this apparatus. FIG. 9B shows the image obtained, and it became possible to identify the macrophage which gave the fluorescence parts shining yellow. By superposing the image of the macrophage on the SEM image (see FIG. 9C), macrophage cells could be observed in distinction from other cells by SEM.

### Example 4

Immunostaining to the rat eyeballs was performed by the following procedure.

1) Eyeball was enucleated, and it was immersed in PFA for 10 minutes 1%, and then a retina was removed.
2) It was immersed to 4% PFA for 1 hour.
3) Wash with PBS (10-minutes×3 times)
4) degreasing-acetone immersion (5 minutes)
5) Wash with PBS (10-minutes×3 times)
6) Blocking (Blocking one of Nacalai Tesque, Inc.) (60 minutes)
7) As a primary antibody of CNV (choroidal neovascularization), rat anti-CD31 antibody (BD pharmigen) diluted to 10 times was incubated for three days at 4° C.
8) Wash with PBS (10 minutes×3 times)
9) As a second antibody of CNV, goat anti-rat InG which was labeled with Alexa flur 546 (red) and diluted to 200 times was incubated for 30 hours at 4° C.
10) Wash with PBS (10 minutes×3 times) for macrophage.
11) As a primary antibody, rabbit Iba-1 antibody (Wako) diluted to 500 times was incubated in one night at 4° C.
12) Wash with PBS (10 minutes×3 times)
13) As a second antibody of macrophagegoat anti-rat InG which was labeled with Alexa flur 488 (green) and diluted to 1000 times was incubated for 3 to 4 hours at 4° C.
14) Washing with PBS (10 minutes×3 times)
15) Acetone dehydration (50-75-85-100% dehydration in ascending concentration order, 100%×2 times (5 minutes each))
16) Aceton was replaced with 100% tert-butyl alcohol (5 minutes×2 times). 17) The sample was dried for about 1.5 hours using freeze dryer (ID-2 manufactured by Eiko Engineering Co.
18) The dried sample was mounted on aluminum stand for sample loading (5 mm in height and 12.5 mm in diameter) with the double-sided tape made of carbon.
19) The sample was coated using osmium plasma coater (HPC-1C manufactured by Vacuum Device Co.) (coating thickness of 2.5 nm).

### (Results)

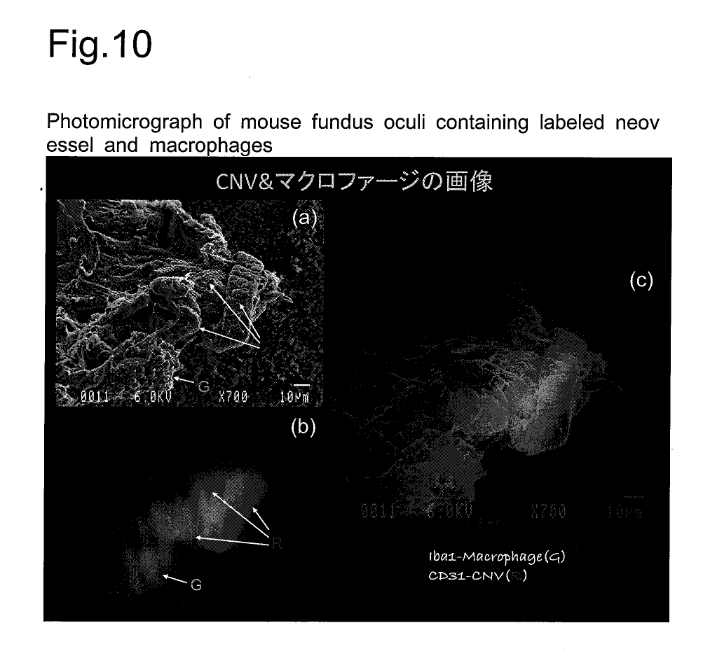

The multi-light microscope used in Example 1 was used for microscopic observation. In FIG. 10, (a), (b) and (c) are a SEM image, a fluorescence image and a fluorescence image obtained using the multi-source microscope of the present invention, respectively. It is considered that the vascular endothelial cell growth factor which grows CNV is emitted from the macrophage. The multi-light source microscope made it possible to observe three-dimensionally the state that the macrophages exist in CNV and also in phlogocyte tissues surrounding the CNV, and the CNV distributes in a range where the CNV is affected by the surrounding macrophages. The obtained image suggests a possibility that the macrophage which locates in an intraretinal tip part and exists nearest to the CNV is promoting CNV formation.

The fluorescence SEM images explained in these Examples 1-4 have not been reported so far and could have been observed for the first time by the present invention. As described above, according to the present invention, since the fluorescence SEM images can be quickly observed, it is possible to provide a living tissue analyzer for practical use combining SEM and the optical microscope.

What is claimed is:

1. A multiple light source microscope which is capable of observing a sample at the same position, comprises an optical microscope unit for observing fluorescence, provided with a light source unit, and a scanning electron microscope unit, wherein the optical microscope has a Cassegrain mirror with an aspherical reflecting surface, and the Cassegrain mirror is arranged in a lens barrel of the scanning microscope unit so as to be coaxial with an optical axis of an electron beam of the scanning electron microscope unit.

2. The multiple light source microscope according to claim 1, wherein the Cassegrain mirror comprises a large mirror having an opening in the center and a small mirror disposed below the opening so as to face the large mirror, and wherein the reflective surfaces of the large mirror and the small mirror are aspherical surfaces.

3. The multiple light source microscope according to claim 1, wherein the light source unit of the optical microscope comprises a plurality of monochromatic light sources and a light synthesizing means to produce a synthetic light by mixing lights from the plurality of monochromatic light sources.

4. The multiple light source microscope according to claim 1, wherein the optical microscope comprises an illumination unit for irradiating a light from the light source unit, an observation camera for observing a return light from the sample, an optical fiber unit for collecting a fluorescence from the sample, and a light path switching mechanism for switching optical path of the return light from the sample to either one of the optical fiber side or the observation camera side.

5. A multiple light source microscope which is capable of observing a sample at the same position, comprises at least a light source unit comprising an electron gun, one or more laser light source and X-ray source which are arranged so as to be movable in the optical axis position, an optical system for irradiating a sample with electromagnetic waves or electron beams from the light source unit, and a detection unit having a fluorescent screen comprising cerium-doped YAG and used for detecting an electromagnetic wave or electron beam transmitted through the sample.

6. The multiple light source microscope according to claim 5, wherein the light source unit comprises a plurality of laser beam sources and a light synthesizing means to produce a synthetic light by mixing lights from the plurality of laser beam sources.
